(19) United States
(12) Patent Application Publication
(10) Pub. No.: US 2013/0176141 A1
(43) Pub. Date: Jul. 11, 2013

(54) SYSTEM AND METHOD FOR CHANGING OPERATIONAL PARAMETERS OF A UTILITY METER

(71) Applicants: Ryan Marc LaFrance, Marietta, GA (US); Scott Michael Shill, Atlanta, GA (US); Michael George Glazebrook, Marietta, GA (US)

(72) Inventors: Ryan Marc LaFrance, Marietta, GA (US); Scott Michael Shill, Atlanta, GA (US); Michael George Glazebrook, Marietta, GA (US)

(73) Assignee: General Electric Company, Schenectady, NY (US)

(21) Appl. No.: 13/344,570

(22) Filed: Jan. 5, 2012

(51) Int. Cl. G08C 19/00

(52) U.S. Cl. 340/870.02

(57) ABSTRACT

A system and method that allow customers to provide acknowledgement to a utility provider for closing a utility meter. One embodiment features an authorization code disposed on the utility meter such that when a customer sends the authorization code to the utility provider as acknowledgement, the utility provider, having received the authorization code, sends a signal to the utility meter that closes the utility meter.

### BACKGROUND OF THE INVENTION

The subject matter disclosed herein relates to utility meters, such as electricity meters, gas meters, and water meters, used to monitor usage at various locations.

A variety of utility service providers place utility meters at various locations to monitor usage of the supplied utility (e.g., electricity, gas, and/or water), thereby enabling proper billing for the supplied utility. For example, a utility service provider may activate a utility meter at a start of utility service, periodically obtain readings from the utility meter during service, and deactivate the utility meter at an end of utility service. Unfortunately, a user or customer generally has no control over the utility meter. Although the customer may view a display (e.g., visible meter indicating usage) on the utility meter, the customer cannot interact with the utility meter to change any operational parameters of the utility meter. For example, the customer cannot provide any user input to enable changes in the operational parameters of the utility meter.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a utility meter configured to measure use of at least one utility distributed to a location having the utility meter, wherein the utility meter is configured to change at least one operational parameter in response to a user input separate from the utility meter.

In a second embodiment, a non-transitory tangible computer-readable medium includes executable code, wherein the executable code comprises instructions for changing at least one operational parameter of a utility meter in response to a user input separate from the utility meter, wherein the utility meter is configured to measure use of at least one utility distributed to a location having the utility meter.

In a third embodiment, a method includes changing at least one operational parameter of a utility meter in response to a user input separate from the utility meter, wherein the utility meter is configured to measure use of at least one utility distributed to a location having the utility meter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagram of an embodiment of a utility infrastructure having a user interaction system configured to enable user interaction with utility meters via a user input device separate from the utility meters and a utility service provider;

FIG. 2 is a diagram of an embodiment of a utility meter having features to enable user interaction via the user input device;

FIG. 3 is a diagram of an embodiment of a utility meter having indicia (e.g., a key or code) to enable user interaction via the user input device;

FIG. 4 is a flow chart of an embodiment of a process of changing a parameter of a utility meter with a customer acknowledgement/authentication via the user input device using a key or code;

FIG. 5 is a flow chart of an embodiment of a process of changing a parameter of a utility meter with a customer acknowledgement via the user input device using a key or code; and

FIG. 6 is a flow chart of an embodiment of a process of changing a parameter of a utility meter with a customer acknowledgement via the user input device using a key or code.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed toward a user interaction system for utility meters, such as electricity meters, gas meters, and water meters. As discussed in detail below, the user interaction system may enable a user or customer to interact with a utility meter via at least one user input device separate from the utility meter and a utility service provider. For example, the user input device may enable the customer to provide user input to control or change at least one operational parameter of the utility meter, such as an activated or deactivated state of the utility meter, a mode of operation of the utility meter, user preferences for operation of the utility meter, or any other controllable feature. By further example, the user input may be a customer acknowledgement or approval to proceed with a particular change in the operational parameter of the utility meter, and such change may be initiated by the utility service provider and/or the customer. In one embodiment, the customer acknowledgement or approval may be used to enable an activation or deactivation of utility service at the utility meter, such as by closing or opening a remote disconnect switch at the utility meter. As discussed below, one or more indicia (e.g., key and/or code) may be displayed on the utility meter, and the customer may provide the acknowledgement or approval to the utility service provider by communicating the indicia over a network via the user input device. One embodiment of the indicia is a quick response (QR) code, which is a type of two-dimensional matrix barcode. Accordingly, the user input device may include a camera to obtain an image of the QR code, which is then communicated over the network to the utility service provider. For example, the indicia may be communicated in a text message, a multimedia message, an e-mail, a website, a software interface, an interactive voice response (IVR) interface, or a combination thereof.

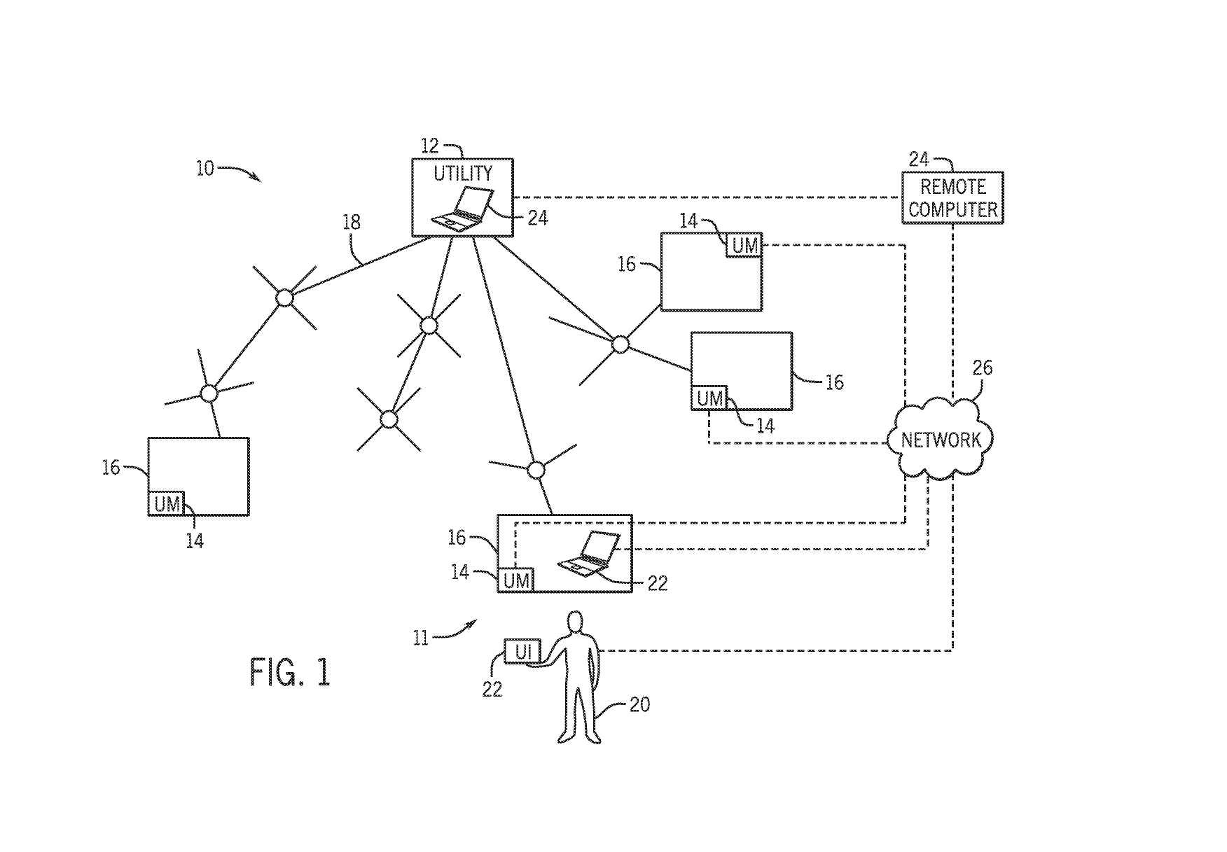

FIG. 1 is a diagram of an embodiment of a utility infrastructure 10 having a user interaction system 11 configured to enable user interaction (e.g., user input) with a utility service provider 12 (e.g., utility) and various utility meters (UMs) 14. As illustrated, the utility provider 12 is coupled to various utility outputs 16 via a utility grid 18 (e.g., a grid or network of power/electricity lines, gas lines, and/or water lines), such that the utility provider 12 is able to distribute a utility service (e.g., power/electricity, gas, or water) to each utility output 16. Each utility output 16 has at least one utility meter 14 configured to monitor and/or control utility service at a particular location. The utility service may include power/electricity service, gas service, and/or water service, and thus the utility meter 14 may be a power/electricity meter, a gas meter, and/or a water meter. As used herein, an energy meter may also refer to a power/electricity meter and/or a gas meter. The utility output 16 may include a variety of residential, commercial, industrial, governmental, and/or public sites, which may include facilities, buildings, equipment, and/or property locations. In operation, each utility meter 14 may measure and record the utility usage of one or more utility outputs 16 and/or utility services.

As illustrated, the user interaction system 11 may include one or more user input (UI) devices 22 (e.g., customer devices) at each utility output 16 (e.g., residential building and/or commercial building), such that a user or customer 20 is able to interact with the on-site utility meter 14. The user input devices 22 may include a variety of computers and electronic devices, such as cell phones (e.g., smart phones), personal digital assistants (PDAs), tablet computers, laptop computers, desktop computers, digital cameras, and various networked devices. For example, each user input device 22 may include a communication module, a digital camera, a memory (e.g., volatile and non-volatile memory), a processor, a display, and software instructions disposed on the memory and executable by the processor. As discussed in further detail below, the user input devices 22 may enable the customer 22 to acknowledge and/or approve a change in at least one operational parameter of the utility meter 14 before the change is made to the utility meter 14. The user input devices 22 also may enable the customer 20 to initiate or request a change in at least one operational parameter of the utility meter 14. For example, as noted above, the change may include an activation or deactivation of utility service at the utility meter 14, a change in the mode of the utility meter 14, a change in user preferences at the utility meter 14, or any other controllable parameter. These changes in the utility meter 14 may be facilitated by one or more indicia (e.g., keys or codes) displayed on the utility meter 14, such that the user input device 22 can communicate the indicia to the utility provider 12 as evidence of customer 20 presence at the meter 14 and/or authorization for the change. The indicia may include a variety of authentication keys such as a text key, an image key, or a combination thereof. For example, the authentication key may include a bar code, such as a quick response (QR) bar code. The user input devices 22 may communicate directly with the utility meter 14, indirectly with the utility meter 14 through the utility provider 12, indirectly with the utility meter 14 through utility devices 24, or any other intercommunication within the utility infrastructure 10. In this manner, the customer 20 can control various operational parameters (e.g., activation or deactivation) of the utility meter 14 independent from the utility meter 14, the utility provider 14, and the utility devices 24, rather than directly interacting with the utility meter 14 itself (e.g., via buttons, dials, etc. on the meter 14).

The utility provider 12 may include one or more utility devices 24, such as on-site computers, remote computers, and portable electronic devices, which may be used to monitor and/or control the grid 18. For example, the utility devices 24 may include one or more servers and/or control stations, which may be specifically configured or programmed (e.g., hardware and/or software instructions) to monitor the distribution of utility services, log service outages and other problems, schedule repairs, schedule activation and deactivation of utility services at various locations, receive user input from user input devices 22, schedule changes in response to such user input, and communicate various messages and/or control signals to the utility meters 14 and the user input devices 22. Accordingly, the utility devices 24 may include a communication module, a memory (e.g., volatile and non-volatile memory), a processor, a display, and software instructions disposed on the memory and executable by the processor. The user input devices 22, utility devices 24, and the utility meter 14 may be configured to communicate with each other and other devices over a network 26. The network 26 may be a personal area network (PAN) such as a Bluetooth network, a local area network (LAN) such as an 802.11x Wi-Fi network, a wide area network (WAN) such as a 3G or 4G cellular network (e.g., WiMax), an infrared (IR) communication link, a Universal Serial Bus (USB) port, and/or a power line transmission network. Using this communications network 26, the user interaction system 11 enables the user input devices 22 to control various aspects of the utility meters 14 without requiring the customer 20 to directly interface with the utility meter 14 (i.e., buttons, dials, etc. on the meter 14).

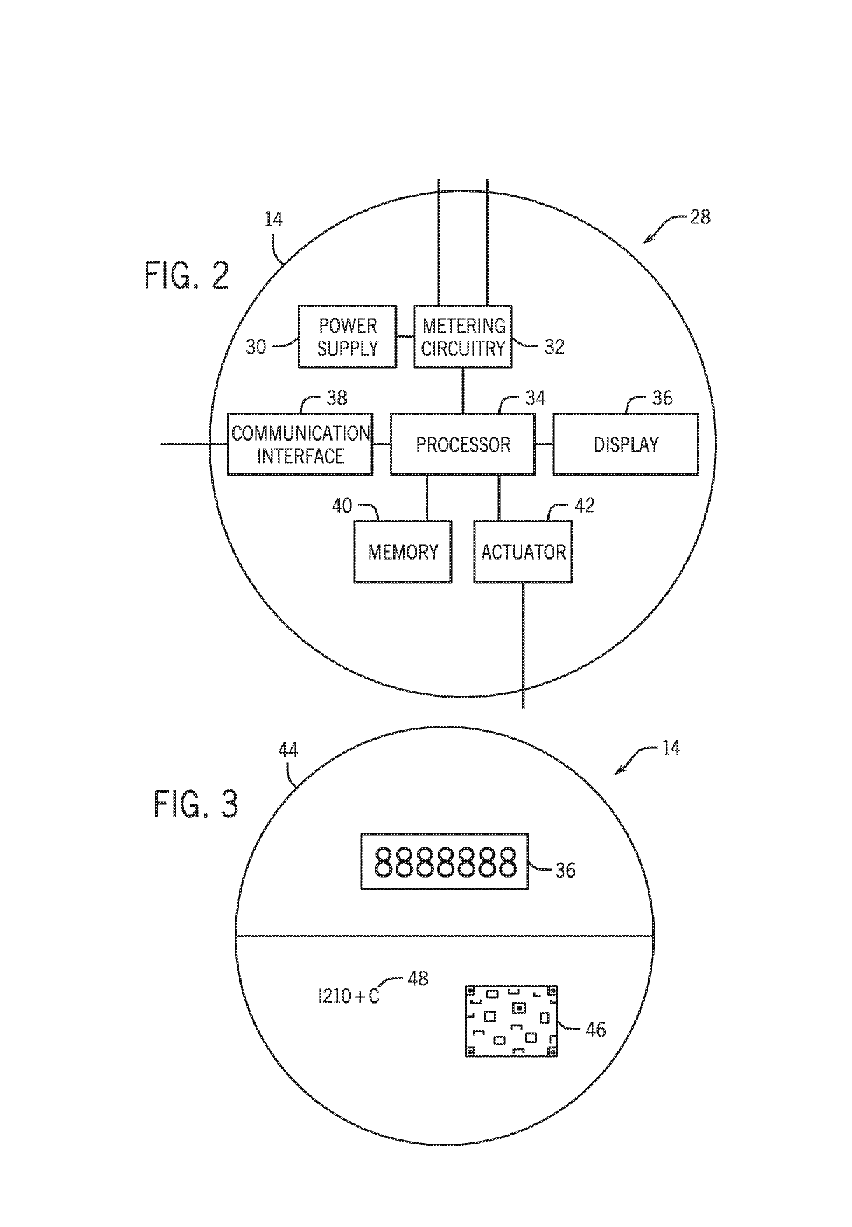

FIG. 2 is a diagram of an embodiment of the utility meter 14 of FIG. 1, illustrating internal components 28 configured to enable monitoring of utility usage, control of utility usage, and user interaction with the utility provider 12 and the user input device 22. As illustrated, the utility meter 14 includes a power supply 30, a metering circuitry 32, a processor 34, a display 36, a communication interface 38, a memory 40, and an actuator 42, among other elements. The power supply 30 provides power to the utility meter 14 for operation of the internal components 28, thereby enabling various functionality of the meter 14. The power supply 30 may be a super capacitor, a battery, external AC power, a photovoltaic/solar panel, and so forth. The metering circuitry 32 is configured to sense the amount of utility consumed at the metering location (e.g., utility output 16). For example, in an electricity meter, the metering circuitry 32 may include sensors that measure the voltage, current, and time. In a gas meter or water meter, the metering circuitry 32 may measure a flow rate and/or aggregate volume of gas (e.g., natural gas) or water supplied to the metering location. Generally, the metering circuitry 32 outputs the data collected by the sensors to the processor 34, where the data is used to calculate utility usage. The calculated utility usage and other parameters may be stored in the memory 40, where it may be constantly or periodically updated. The processor 34 may be configured to output utility usage data to the display 36 (e.g., liquid crystal display), where it appears in a human readable format. In addition to outputting the amount of utility consumed, the processor 34 may also perform various other calculations and process other data. The same or a separate processor 34 may be configured to control other functions of the utility meter 14, such as processing signals received from other devices via the communication interface 38, carrying out programmed tasks, sending signals to other devices, and so forth.

In one or more embodiments, the processor 34 may also send the processed usage data to the communication interface 38, where it may be transmitted, via the network 26, to a device at another location, such as the user input device 22, the utility device 24, or other device. The communication interface 38 may also transmit and receive other signals to and from other devices. The communication interface 38 may include an interface for communicating over a personal area network (PAN) such as a Bluetooth network, a local area network (LAN) such as an 802.11x Wi-Fi network, a wide area network (WAN) such as a 3G or 4G cellular network (e.g., WiMax), an infrared (IR) communication link, a Universal Serial Bus (USB) port, and/or a power line transmission network. The memory 40 (e.g., volatile or non-volatile memory) may also contain computer executable code, such as instructions for carrying out different functions, conditional operations, storing location and identity data, and so forth. In one or more embodiments, the utility meter 14 may include a geographic positioning system (GPS) for location purposes.

The actuator 42 may be any switch, valve, or control mechanism, which controls the flow of the utility (e.g., electricity, gas, or water) to the respective utility output 16, depending on the type of utility being delivered and the corresponding type of utility meter 14. For example, the actuator 42 may be an electronically actuated switch, such as a remote disconnect (RD) switch, to control the activation and deactivation of electricity to the utility output 16. By further example, the actuator 42 may be an electronically actuated valve, which may be used to open, close, or generally vary the flow rate of gas or water to the utility output 16. However, the actuator 42 may include any type of control mechanism that is controllable via the utility meter 14, the user input devices 22, and/or the utility devices 24.

In certain embodiments, internal components 28 may be specifically designed or programmed (e.g., hardware and/or software instructions) to enable direct user interaction with the user input device 22. Again, the user input device 22 may include a cell phone (e.g., a smart phone), a tablet computer, a handheld device, or any other suitable consumer electronic device with a communication module suitable to communicate with the communication interface 38. For example, the user input device 22 may communicate with the communication interface 38 via one or more wireless communications standards. The user input device 22 may enable the customer 20 to acknowledge or approve a particular control action at the utility meter 14, such as by communicating an authentication key, user identification key, user account number, or other unique identify that verifies the customer's approval of the control action. For example, the user input device 22 may acquire a digital photo of a key or code (e.g., a QR barcode) on the face or display 36 of the utility meter 14, and then communicate this key or code directly to the utility meter 14 as evidence of approval. Upon receipt, the utility meter 14 may process the received data (e.g., key or code) on-site, and then enable the control action to continue. Alternatively, the utility meter 14 may communicate the received data (e.g., key or code) to the utility devices 24 (e.g., remote computers), which may then remotely process the received data and either approve or disapprove the control action.

In other embodiments, the user interaction system 11 may be configured to enable the user input device 22 to communicate with the utility devices 24 (e.g., remote computers), which in turn communicate with the utility meter 14. Again, the user input device 22 may include a cell phone (e.g., smart phone), a tablet computer, a handheld device, or any other suitable consumer electronic device with one or more communication functions or software, such as an e-mail application, a text messaging application, a multimedia messaging application, a web-based user interface, and/or a local software application with communications functionality. For example, the user input device 22 may communicate with the utility devices 24 over one or more wired and/or wireless communications networks 26, such that the devices 22, 24 can exchange control requests, user authentication messages, security verification messages, acknowledgement messages, and so forth. For example, the user input device 22 may enable the customer 20 to acknowledge or approve a particular control action at the utility meter 14 (e.g., by communicating an authentication key, user identification key, user account number, or other unique identify that verifies the customer's approval of the control action) to the utility devices 24. For example, the user input device 22 may acquire a digital photo of a key or code (e.g., a QR barcode) on the face or display 36 of the utility meter 14, and then communicate this key or code to the utility device 24 as evidence of approval. Upon receipt, the utility device 24 may process the received data (e.g., key or code) off-site, and then enable the control action to continue by sending a control message to the utility meter 14 on-site. In certain embodiments, the control action may include an activation or deactivation of the utility meter 14, e.g., change position of the actuator 42 to enable or disable flow of the utility service at the utility output 16. However, the control action also may include various changes to the operation parameters of the utility meter 14, such as a power saving mode, a real time pricing (RTP) driven mode, a user preference mode, or any other type of programmable mode of the meter 14.

FIG. 3 is a diagram of an embodiment of the utility meter 14 of FIGS. 1 and 2, illustrating a face 44 of the utility meter 14 having the display 36, a unique indicia 46, and a unique indicia 48. The display 36 may be a liquid crystal display (LCD), a light emitting diode (LED) display, an organic light emitting diode (OLED) display, a dot matrix display, a seven segment display (SSD), a fourteen segment display, or any combination thereof. The indicia 46 and 48 may include a variety of authorization keys or codes, such as text keys, image keys, or a combination thereof. For example, the indicia 46 and 48 may include keys or codes, such as serial numbers, bar codes, alphanumeric security keys, or any combination thereof. In the illustrated embodiment, the indicia 46 includes a two-dimensional barcode, e.g., a quick response (QR) code 46, while the indicia 48 includes a meter identifier (ID) 48. Similar indicia (e.g., keys or codes) also may be temporarily displayed on the display 36 as part of an authentication procedure for various control actions at the utility meter 14. As discussed further below, these indicia (e.g., 46 and/or 48) may be used by the user input device 22 to enable the control actions at the utility meter 14, e.g., by communicating these indicia (e.g., 46 and/or 48) to the utility devices 24 and/or the utility meter 14.

The display 36 may be configured to display utility usage data (e.g., current usage per time, aggregate usage, or both), real time pricing of the utility, operational mode data of the meter 14, messages from the utility provider 12 (e.g., utility devices 24), user prompt messages (e.g., requiring user input to continue), change acknowledgement messages, and so forth. For example, display 36 may be configured to display messages for the customer with updates or requests for certain actions to be done by the customer, with the messages being stored in the memory 40 and programmed to be displayed under predetermined conditions. The meter ID 48 and quick response (QR) code 46 generally identify the utility meter 14 and are linked to data regarding the utility meter 14, such as customer name, account, location, usage, and so forth.

In the present embodiment, the utility meter 14 not only measures utility usage, but it may also control delivery of the utility (e.g., electricity, gas, or water) to the respective utility output 16. This may include turning the utility on or off at the respective utility output 16 in response to a signal from the utility provider 12. The signal may contain a computer executable command, which is received by the communication interface 38. Upon processing the signal, the processor 34 sends another signal to the actuator 42 to turn the utility on or off in accordance with the command. For example, the command may be sent from the utility provider 12 to the utility meter 14 in response to a service change request, such as a new customer and/or service location, a defaulting customer and/or service location, service cancellation, and so forth.

Referring generally to FIGS. 1 and 3, the user input devices 22 and the utility devices 24 may be desktop computers, laptop computers, tablet computers, landline telephones, cellular telephones, smartphones, industry-specific devices, application-specific devices, other suitable existing and new devices, and any combination of the above. These devices 22 and 24 may include power supplies, processors, memories, displays, user interface elements, wired and wireless communication interfaces, and other electronic components for carrying out a wide range of functions. Specifically, such devices 22 and 24 may include hardware elements (e.g., suitable circuitry) and software elements (e.g., computer code stored on a non-transitory, tangible, machine readable medium). The user input devices 22 and utility devices 24 may include applications or programs specifically suited for communications with each other and with the utility meter 14. In some embodiments, the user input devices 22 and utility devices 24 may include global positioning (GPS) circuitry that provide information regarding the location of the respective device. Further, the user input devices 22 and utility devices 24 may also include networking circuitry, such as a network controller or network interface card (NIC) for supporting communication over the network 26. Any discussion of communications herein (e.g., sending, receiving, transmitting, etc.) are intended to include any form of wired or wireless communications standards, any form of communications techniques (e.g., text messaging, multimedia messaging, e-mail, web-based interfaces, software interfaces, etc.), and any combination of communications among the utility provider 12 and associated utility devices 24, the customer 20 and associated user input device 22, and the utility output 16 and associated utility meter 14.

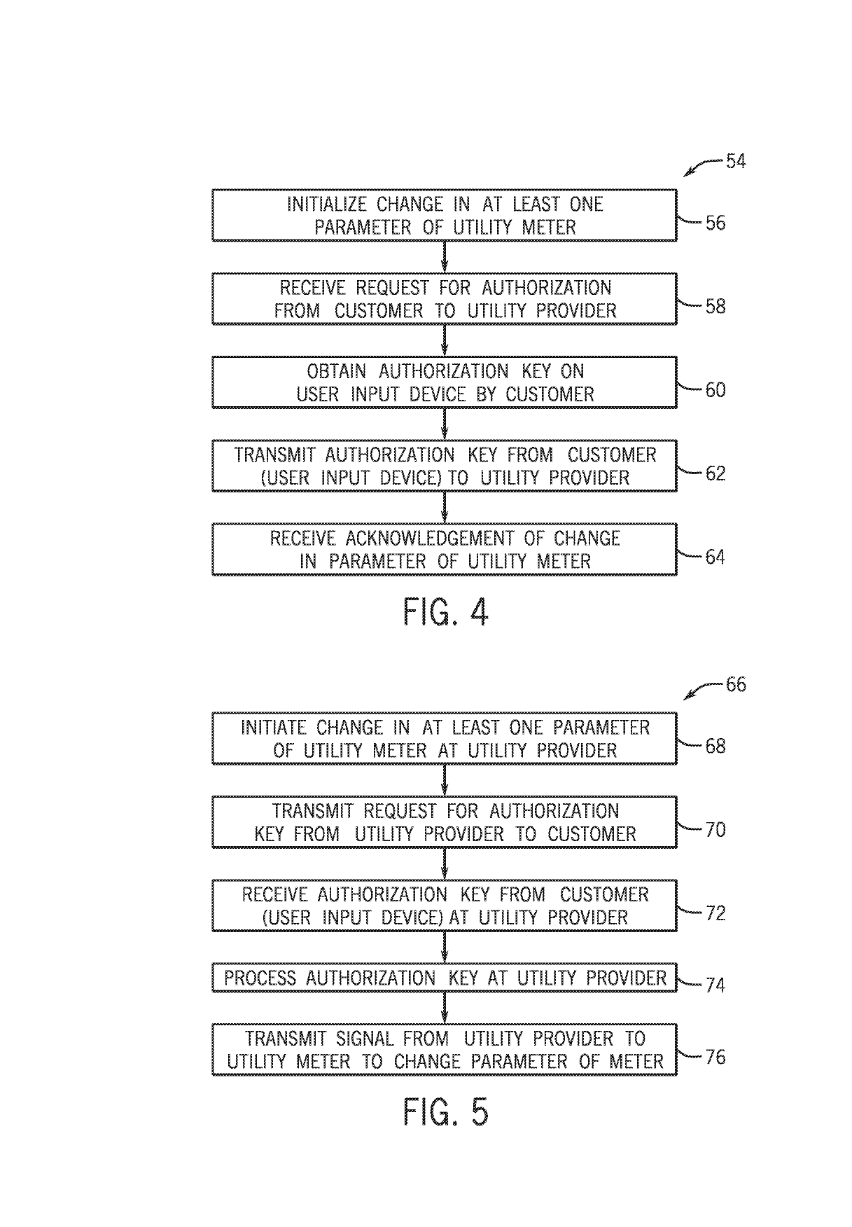

The disclosed embodiments enable user input (e.g., acknowledgement and/or authentication) in various processes to change operational parameters of the utility meter 14. FIG. 4 is a flow chart of an embodiment of a process 54 of changing a parameter of a utility meter 14 with a customer acknowledgement/authentication via a user input device 22. As illustrated, the process 54 begins by initiating a change in one or more parameters of the utility meter 14 (block 56). The change initiation (block 56) may be initiated by the utility provider 12 (e.g., utility device 24) or the user/customer 20 (e.g., the user input device 22). For example, the change initiation (block 56) may include a change in state of the utility meter 14 between activated and deactivated (e.g., allow or block utility service). This may occur prior to or during the start of a service contract or reinstatement of service so that the meter 14 may be activated at the scheduled time.

The process 54 may proceed by receiving a request for authorization from the customer 20 to the utility provider 12 (block 58). For example, the user input device 22 and/or the utility meter 14 may receive the request for authorization (block 58) from the utility device 24. The request for authorization (block 58) may be sent via electronic communication, e.g., a suitable communication protocol over a wired or wireless network. Some embodiments may transmit the request (block 58) to the user input device 22 via an e-mail, text/multimedia message, a dedicated application (e.g., smart phone app), or any combination thereof. The request (block 58) may also reach the customer 20 via other forms of communication, such as by mail, phone call, an instruction manual, and so forth. With electronic communication, the customer 20 may view the request for authorization (block 58) on a display of the user input device 22 and/or utility meter 14. In certain embodiments, the request (block 58) may describe how to provide the authorization, e.g., enter key code viewable on the utility meter 14, transmit digital photo of QR bar code to utility provider 12 via the user input device 22, etc. However, some embodiments of the utility meter 14 may include a unique key (e.g., QR bar code) and instructions disposed directly on the meter 14, e.g., inscribed on the casing of the meter 14, printed on a label adhered to the meter 14, or both. The instructions (e.g., label) may explain how to provide authorization/authentication to the utility provider 12 upon receipt of a request for authorization (block 58).

Upon receipt of the request (block 58), the process 54 may proceed by obtaining an authorization/authentication key on the user input device 22 (block 60), e.g., the customer 20 may obtain the key on-site at/near the utility meter 14. The key acquisition (block 60) may include one or more customer 20 actions to locate, identify, and/or electronically acquire a representation of the authorization key, such as data representing an image and/or text of the key. For example, the customer 20 may use the user input device 22 (e.g., digital camera, scanner, or the like) to acquire a digital image of a key (e.g., image and/or text) disposed on the utility meter 14. Images may include unique shapes, bar codes, and so forth. Bar codes may include linear barcodes or two-dimensional bar codes, such as Aztec codes, High Capacity Color barcodes, and/or QR bar codes. Text may include unique authentication keys, customer/account numbers, serial numbers of meters 14, customer passwords, and so forth. By further example, the customer 20 may use the user input device 22 to enter the key, e.g., an alphanumeric key.

After obtaining the key (block 60), the process 54 may proceed by transmitting the key from the customer 20 (e.g., user input device 22) to the utility provider 12 (e.g., utility device 24) as indicated by block 62. The customer transmission (block 62) may include a variety of electronic communication forms, such as e-mail, text/multimedia messages, dedicated applications (e.g., smart phone app), computer software, website (e.g., web interface), interactive voice response (IVR) systems, computer-telephone integration (CTI) systems, or any combination thereof. For example, the customer 20 may use the user input device 22 to acquire a digital image of a QR bar code (e.g., QR code image) disposed on the utility meter 14, and then electronically communicate the QR code image to the utility provider 12 via the same device 22 or a different user input device 22. For example, the customer 20 may acquire the QR code image via a digital camera or a smart phone, and then transit the QR code image via the smart phone or a computer (e.g., desktop, laptop, or tablet computer).

By further example, the key (e.g., an alphanumeric key) may also be entered and transmitted to the utility provider 12 via the IVR system, e.g., using voice response entry or telephone keypad response entry on a telephone. For example, the customer 20 may call a number using a telephone, and when prompted, verbally provide the key and/or enter the key via an alphanumeric pad on the telephone. The text based code may be used to identify the respective utility meter 14, and may be linked to other parameters such as geographic location of the meter, serial number, customer information, meter calibration data, and other data associated with the utility meter 14.

Some embodiments may utilize the CTI system, where the customer 20 may input an alphanumeric key by calling a phone line, generally operated by or affiliated with the utility provider 12. The CTI system may link one or more telephones with one or more computers, such that a telephone may be controlled by a computer and vice versa. Such embodiments of the CTI systems may further include IVR capabilities or dual-tone multi-frequency (DTMF) signal capabilities. For example, the customer 20 may call a phone number connecting the customer's telephone with the utility provider's telephone. The utility provider's telephone, being linked to a computer through the CTI system, may prompt the customer 20 to verbally input the alphanumeric key into the customer's telephone. The customer's speech may then be processed by the linked computer using voice recognition techniques. Thus, data containing the alphanumeric key is sent to the utility provider 12. Alternatively, the customer 20 may be prompted to input the alphanumeric key using dual-tone keys on their telephone, which are generally processed by the integrated computer through DTMF signal processing techniques, resulting in receipt of the alphanumeric key by the utility provider 12. In certain embodiments, receipt of the authorization key or code may be considered receipt of acknowledgement from the customer 20. Additionally, some embodiments may include a website, where the customer 20 may input the authorization key, and the website may be configured to send the entered authorization key to the utility provider 12 as acknowledgment. The above functions may be executed on the user input device 22 as described above.

After the key transmission (block 62), the customer 20 may receive an acknowledgment of a change in the parameter of the utility meter 14 on the user input device 22 and/or the utility meter 14 (block 64). For example, a display of the user input device 22 and/or the utility meter 14 may output a message indicating an acceptance of the authorization key and/or a change in the parameter (e.g., service activation complete, service deactivation complete, etc.) Accordingly, before such acknowledgement (block 64), the utility provider 12 (e.g., utility device 24) may process the authorization key (e.g., QR code image), verify its authenticity, and then proceed to send a signal to the utility meter 14 to execute a change in the parameter at the utility meter 14. In one embodiment, the utility provider 12 (e.g., utility device 24) sends a signal to the utility meter 14 for activating service (e.g., closing a switch) at the utility meter 14, thereby enabling output of utility service (e.g., electricity, water, or gas) at the particular location and beginning to record usage for billing and data purposes. For example, the signal sent from the utility provider 12 may carry instructions in the form of data to be processed by the processor 34 of the utility meter 14. The processor 34 may then send a corresponding signal to the actuator 42, which takes the appropriate action with regard to utility flow.

FIG. 5 is a flow chart of an embodiment of a process 66 of changing a parameter of a utility meter 14 with a customer acknowledgement via the user input device 22 using a key or code. For example, the process 66 may use QR code (e.g., 46), which is a two dimensional, matrix barcode, having black modules arranged on a white background, generally in a square shape. The QR code 46 is a machine readable media with the arrangement of the black modules representing data. The QR code 46 may be used to encode any data type, including binary, alphanumeric, and so forth. The QR code 46 may be disposed on the face 44 of the utility meter 14 as shown in FIG. 3, on the side of the utility meter 14, inside the meter 14, or elsewhere.

In the illustrated embodiment, the process 66 initiates a change in at least one parameter (e.g., activation state) of the utility meter 14 at the utility provider 12 (e.g., utility device 24) as indicated at block 68. For example, the utility provider 12 may initiate the change in response to a customer 20 request for service activation or service deactivation of electricity, water, or gas at a customer's residence. The process 66 may then transmit a request for authorization (e.g., key) from the utility provider 12 (e.g., device 24) to the customer 20 (e.g., input device 22) as indicated at block 70. The request transmission 70 may include a message displayed on the utility meter 14 and/or the user input device 22. For example, the utility provider 12 (e.g., device 24) may send an e-mail, text/multimedia message, or other electronic communication over a wired or wireless network to the meter 14 and/or user input device 22. The message may prompt the customer 20 to provide the authorization key separate from the utility meter 14, e.g., via the user input device 22. For example, the message may request a digital image of the QR code 46. However, the authorization key may be any type of text or image key as discussed above. The process 66 may then receive the authorization key from the customer 20 (e.g., user input device 22) at the utility provider 12 (e.g., utility device 24) as indicated at block 72. For example, the utility provider 12 (e.g., device 24) may receive an electronic communication (e.g., e-mail, text/multimedia message, web interface transmission, software transmission, etc.) with a digital image of the QR code 46. Again, any suitable electronic communication may be used for the QR code transmission 72. At this point in the process 66, the utility provider 12 (e.g., device 24) may process the authorization key (e.g., QR code 46) from the customer 20 (block 74). For example, the utility device 24 may compare the received QR code 46 with an expected QR code, and confirm the validity of the code 46 if a match is found. In some embodiments, the QR code 46 may be decoded at the user input device 22 rather than the utility device 24. Upon confirming the validity of the code 46, the process 66 may transmit a signal from the utility provider 12 (e.g., device 24) to the utility meter 14 to change the parameter of the meter 14 (block 76). For example, the signal may initiate a change in activation state of the utility meter 14, e.g., an activated state providing service (e.g., electricity, water, or gas) through the meter 14 or a deactivated state blocking service through the meter 14.

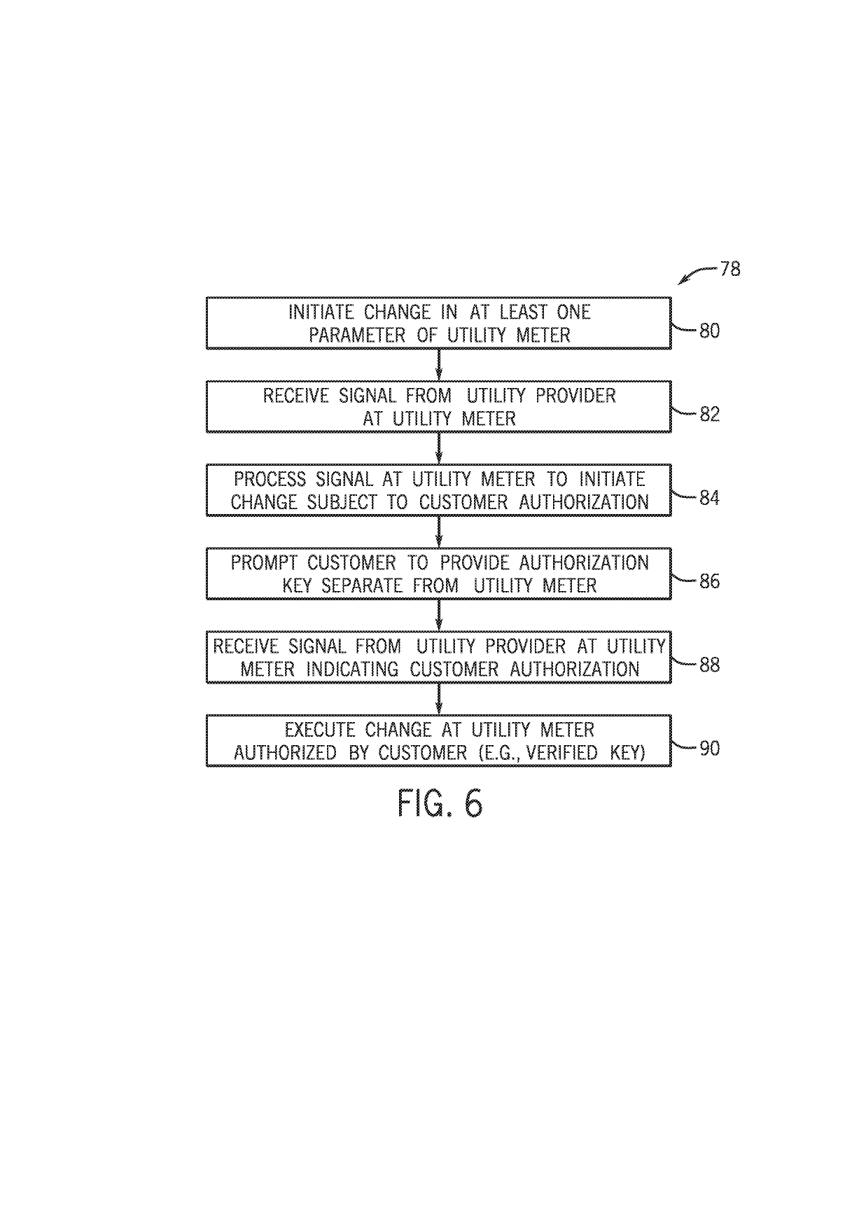

FIG. 6 is a flow chart of an embodiment of a process 78 of changing a parameter of a utility meter 14 with a customer acknowledgement via the user input device 22 using a key or code (e.g., QR code). As illustrated, the process 78 begins by initiating a change in one or more parameters of the utility meter 14 (block 80). The change initiation (block 80) may be initiated by the utility provider 12 (e.g., utility device 24) or the user/customer 20 (e.g., the user input device 22). Once initiated, the process 78 includes receiving a signal from the utility provider 12 (e.g., utility device 24) at the utility meter 14 as indicated at block 82. In some embodiments, the signal (block 82) may be received at the user input device 22 in addition to, or instead of, the utility meter 14. Upon receipt of the signal (block 82), the utility meter 14 processes the signal to initiate the change (e.g., activation state) of the utility meter 14 subject to customer 20 authentication (e.g., verification of key) as indicated at block 84. The process 78 may then prompt the customer 20 to provide an authorization key (e.g., text and/or image) separate from the utility meter 14 (block 86). For example, the utility meter 14 may display a message requesting the customer 20 to acquire and electronically transmit the key (e.g., text and/or image) via the user input device 22. As discussed in detail above, the key may be a QR code fixed to or displayed on the utility meter 14, such that the customer 20 can obtain a digital image of the QR code and return the QR code to the utility provider 12 (e.g., device 24) via an appropriate electronic communication using the input device 22. In this manner, the customer 20 authorization is separate from the utility meter 14 to improve security and simplify the construction of the utility meter 14. For example, the utility meter 14 may be constructed without any user input buttons directly on the meter 14. As discussed above, the utility provider 12 (e.g., device 24) may process the key (e.g., QR code), verify its authenticity, and then a signal to the utility meter 14. Accordingly, the process 78 may then receive a signal from the utility provider 12 (e.g., device 24) at the utility meter 14 indicating customer authorization/authentication (block 88). At this point in the process 78, the utility meter 14 may execute the change (e.g., activate or deactivate service) at the utility meter 14 as authorized by the customer 20, e.g., verified key-QR code (block 90).

Technical effects of the invention include, among other things, the use of authorization/authentication keys (e.g., QR codes) to enable changes of one or more parameters on a utility meter 14. The keys are transmitted by the customer 20 separate from the utility meter 14, such as through a user input device 22 separate from the meter 14. In this manner, the customer 20 may not need to press a button or generally input a command directly on the utility meter 14. The use of keys (e.g., QR codes) may enhance security of the utility meters 14, while also providing greater flexibility in customer 20 approval using various input devices 22 (e.g., smart phones, laptop computers, etc.). In some embodiments, the customer 20 may obtain a digital image of the key (e.g., QR code image) disposed on the utility meter 14, store the QR code image in memory on the user input device 22, and then subsequently use the QR code image each time a change is requested for the utility meter 14. Accordingly, the customer 20 may be able to authorize changes in the utility meter 14 without being physically present at the meter 14. The user input device 22 also may provide added security such as a user login identification and password, a fingerprint reader, a retinal scanner, or other user authentication.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a utility meter configured to measure use of at least one utility distributed to a location having the utility meter, wherein the utility meter is configured to change at least one operational parameter in response to a user input separate from the utility meter.

2. The system of claim 1, wherein the user input comprises an authorization key.

3. The system of claim 2, wherein the authorization key comprises at least one of a text key, or an image key, or a combination thereof.

4. The system of claim 2, wherein the authorization key comprises a bar code.

5. The system of claim 2, wherein the utility meter is configured to change the at least one operational parameter in response to a communication of the authorization key over a network from a device separate from the utility meter.

6. The system of claim 2, wherein the utility meter is configured to provide the authorization key on the utility meter.

7. The system of claim 1, wherein the user input comprises data communicated in a text message, a multimedia message, an e-mail, a website, a software interface, or an interactive voice response (IVR) interface, or a combination.

8. The system of claim 1, wherein the utility meter comprises a display configured to display a message to prompt a user to provide the user input separate from the utility meter.

9. The system of claim 1, wherein the utility meter is configured to change the at least one operational parameter in response to the user input prompted by a message on a device separate from the utility meter.

10. The system of claim 1, wherein the utility meter is configured to change the at least one operational parameter in response to the user input on a computer, a phone, or a portable electronic device, or a combination thereof.

11. The system of claim 1, wherein utility meter is configured to measure use of the at least one utility comprising electricity, water, or gas, or a combination thereof.

12. A method, comprising:
changing at least one operational parameter of a utility meter in response to a user input separate from the utility meter, wherein the utility meter is configured to measure use of at least one utility distributed to a location having the utility meter.

13. The method of claim 12, comprising displaying a message on the utility meter to prompt a user to provide the user input separate from the utility meter.

14. The method of claim 12, comprising transmitting a message to a device separate from the utility meter to prompt a user to provide the user input separate from the utility meter.

15. The method of claim 12, comprising receiving a first data with the user input from a user device at a remote computer both separate from the utility meter; and sending a second data from the remote computer to the utility meter to trigger change of the at least one operational parameter of the utility meter.

16. The method of claim 12, comprising receiving the user input from at least one of a computer, a phone, or a portable electronic device separate from the utility meter.

17. The method of claim 12, wherein the user input comprises an authorization key.

18. The method of claim 12, wherein the user input comprises data communicated in a text message, a multimedia message, an e-mail, a website, a software interface, or an interactive voice response (IVR) interface, or a combination.

19. A non-transitory tangible computer-readable medium comprising executable code, wherein the executable code comprises instructions for:
changing at least one operational parameter of a utility meter in response to a user input separate from the utility meter, wherein the utility meter is configured to measure use of at least one utility distributed to a location having the utility meter.

20. The non-transitory tangible computer-readable medium of claim 19, wherein the user input comprises an authorization key communicated in a text message, a multimedia message, an e-mail, a website, a software interface, or an interactive voice response (IVR) interface, or a combination.
